(19) United States
(12) Patent Application Publication
(10) Pub. No.: US 2007/0057009 A1
(43) Pub. Date: Mar. 15, 2007

(54) Attachment for use with a palm nailer

(76) Inventors: Paul Thorne, Jacksonville, FL (US); Anthony D. Peacher, Atlantic Beach, FL (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/509,460

(22) Filed: Aug. 24, 2006

Related U.S. Application Data
(60) Provisional application No. 60/714,944, filed on Sep. 7, 2005.

(51) Int. Cl. B25C 5/06

(52) U.S. Cl. 227/120

(57) ABSTRACT

An attachment for a palm nailer that allows the palm nailer to be used for planishing metal is disclosed. A cylindrical portion with a threaded end is attached to a palm nailer through a receiving end, and a head piece suitable for planishing metal is secured to the threaded end. In operation, the palm nailer pneumatically engages the attachment, which causes the attachment to vibrate at a high rate of speed. This in turn allows the palm nailer to be used to planish metal.

### CROSS REFERENCE TO RELATED CLAIMS

This application claims benefit to provisional application 60/714,944, filed Sep. 7, 2005, entitled “Attachment for Use with a Palm Nailer”, which is incorporated by reference herein in its entirety.

### FIELD OF THE INVENTION

The present invention is directed to the field of devices for finishing or burnishing metals and the like. In particular, the present invention is directed to an attachment which enables the palm nailer to be used as a miniature hand-held power hammer for metal forming.

### BACKGROUND OF THE INVENTION

Palm nailers are frequently used for tasks that require repetitive nailing. Accordingly, palm nailers typically include a cylindrical mechanical system for driving nails of various sizes into surfaces. The typical palm nailer includes a pneumatic attachment for operating the device.

There have been a few patents directed to the area of palm nailers. U.S. Pat. No. 6,443,348 discloses a palm nailer including a magazine for driving of successive nails without need for reloading, the magazine being incorporated onto the nose of the nailer, and enabling a 360 degree rotation of the magazine about the axis of the nose tool and driver blade. The nailer is adapted with a “D” shaped driver blade for driving nails with a circular head. The nailer drives each nail with multiple blows of the driver blade while maintaining the nail in the magazine adjacent the nail being driven out of the path of the driver blade until completion of the driving of the operative nail and retraction of the tool from the workpiece into which the nail is driven.

U.S. Patent Application No. 20010042768 is directed towards palm nailer including a magazine for driving of successive nails without need for reloading, the magazine being incorporated onto the nose of the nailer, and enabling a 360 degree rotation of the magazine about the axis of the nose tool and driver blade. The nailer is adapted with a “D” shaped driver blade for driving nails with a circular head. The nailer drives each nail with multiple blows of the driver blade while maintaining the nail in the magazine adjacent the being driven out of the path of the driver blade until completion of the driving of the operative nail and retraction of the tool from the workpiece into which the nail is driven.

U.S. Design Pat. No. D462,589 is directed towards an ornamental design for a palm nailer.

While there have been a number of palm nailers, none have included a mechanism which permits the attachment of shaping tools and the like.

### SUMMARY OF THE INVENTION

It is an object of the present invention to provide an attachment for a palm nailer through which a planishing head piece may be attached.

It is a further object of the present invention to provide an attachment for a palm nailer which enables the palm nailer to be used to form and shape metals.

In view of the foregoing objects, the present invention is directed to an attachment for a palm nailer that allows the palm nailer to be used for planishing metal. The invention works in conjunction with a palm nailer by pneumatically attaching to its operative end. The nailer causes the attachment to vibrate rapidly. At the end of the attachment is a flat or rounded head piece that is suitable for planishing metal. The attachment is threaded on the end that is not connected to the palm nailer. This allows a variety of head pieces with threaded recesses to be screwed onto the threaded end of the attachment.

### BRIEF DESCRIPTION OF THE FIGURES

FIG. 1 is a perspective view of the present invention.

FIG. 2 is an perspective view of the present invention, shown here with the attachment separated from the palm nailer.

FIG. 3 is a perspective view of an embodiment of the present invention.

FIG. 4 is a perspective view of an embodiment of the present invention.

FIG. 5 is a perspective view of an embodiment of the present invention.

FIG. 6 is a side elevational view of a head piece of the present invention.

FIG. 7 is a side elevational view of a head piece of the present invention.

FIG. 8 is a side elevational view of a head piece of the present invention.

FIG. 9 is a side elevational view of a head piece of the present invention.

FIG. 10 is bottom plan view of the present invention

FIG. 11 is a top plan view of the present invention.

FIG. 12 is a side elevational view of the present invention.

### DESCRIPTION OF THE PREFERRED EMBODIMENT

The present invention is described with reference to the enclosed description wherein the same numbers are used where applicable. The present invention is directed to an attachment for a palm nailer 10. This invention allows a palm nailer to be used as a miniature hand-held power hammer for metal forming, burnishing and the like.

Palm nailers can impact a surface over two thousand times per minute. This is substantial especially when compared to regular hammers, which can deliver a maximum of about eighty impacts per minute when they are operated by a skilled user. Due to the large number of impacts, a palm nailer, adapted with the present invention, is more than adequate to planish metal. The critical feature of the invention is a threaded shaft with detachable head pieces 16, 18, 20 that are suitable for engaging a metal surface.

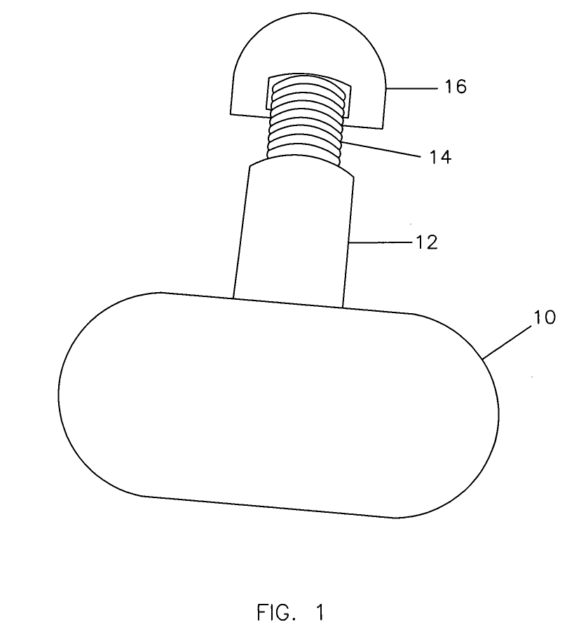

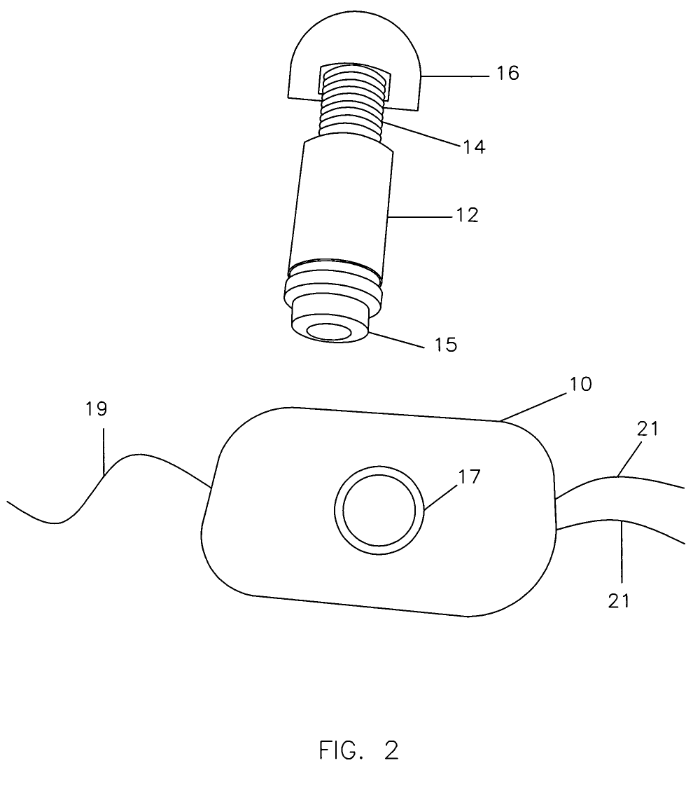

Referring to FIGS. 1 and 2, the present invention comprises a cylindrical member 12 with a series of threads 14 which allow various head pieces 16, 18, 20 to be attached to it. The receiving end 15 of the device attaches to a palm nailer 10. The receiving end 15 has an aperture through which it is pneumatically powered by the palm nailer. As shown in FIG. 2, the nailer 10 includes pneumatic lines 21 and a power cord 10. The attachment shaft 12 measures preferably about one to two inches in width and one-half inch in diameter and is composed of hardened steel. The shaft 12 and head pieces 16, 18, 20 are easily attached to available palm nailer 10. This attachment makes the palm nailer operate as a planishing, burnishing or finishing hammer.

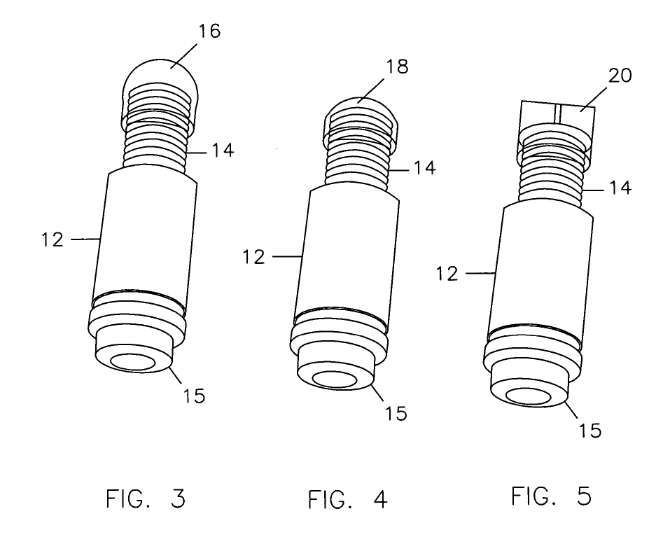

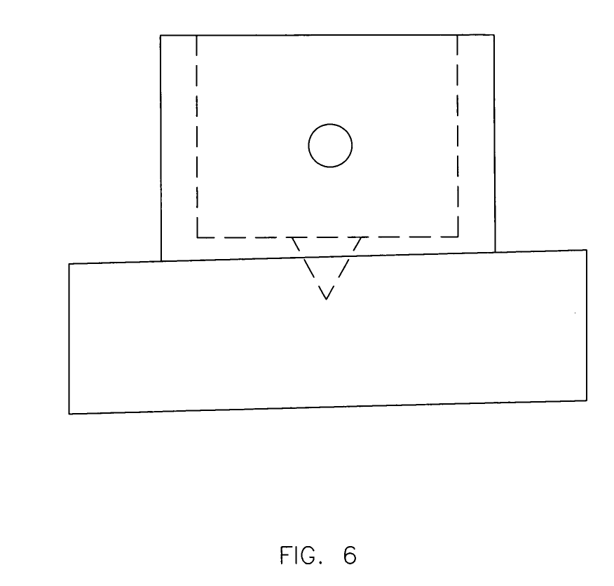

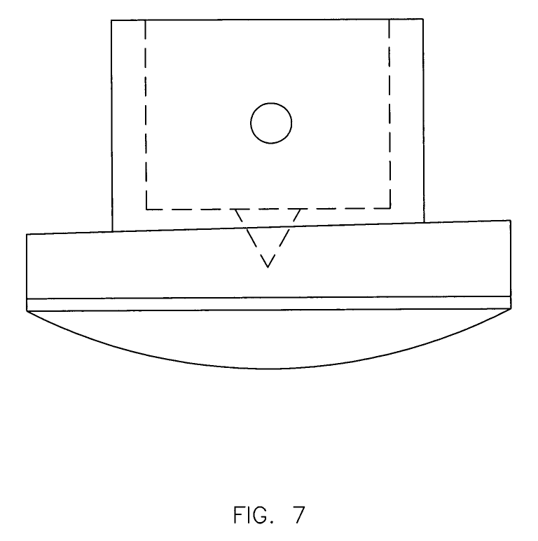

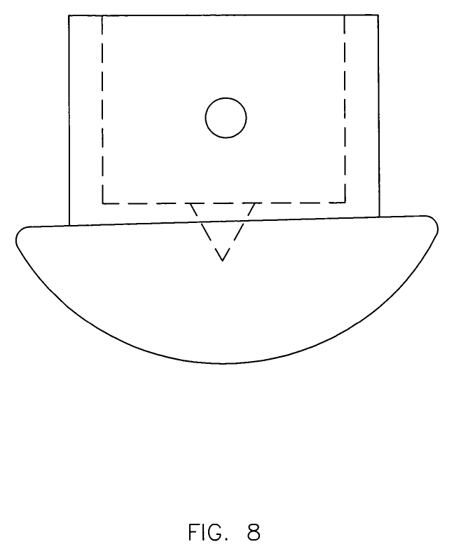

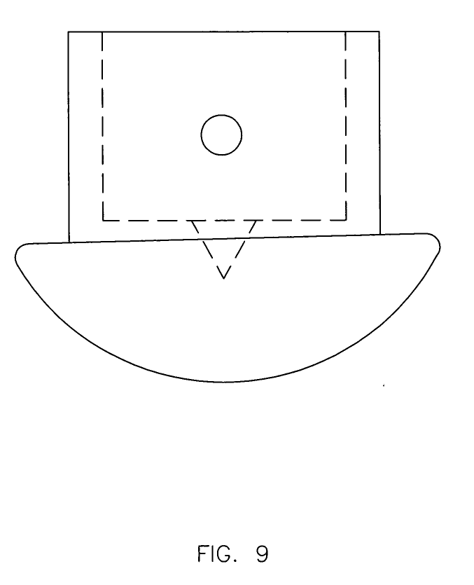

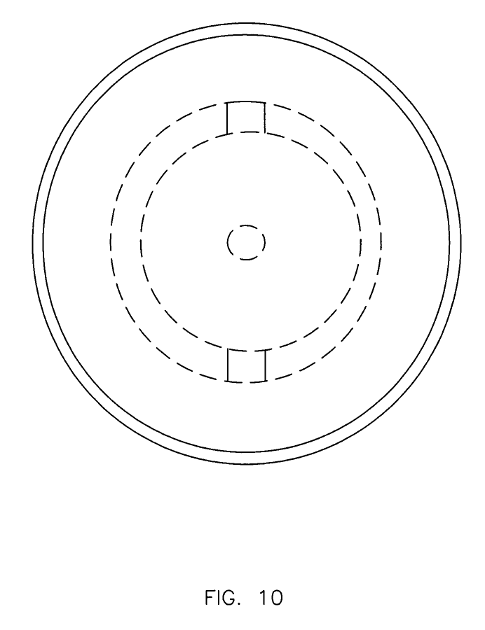

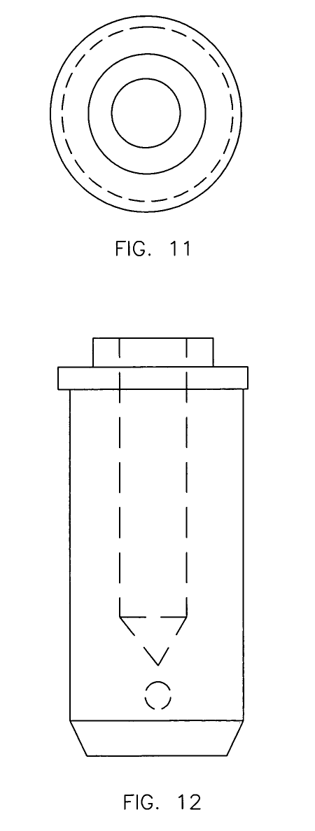

Referring to FIGS. 3-9, a variety of head pieces for use with the device are set forth. Referring to FIGS. 10 and 11, the engaging and non-engaging portions of the cylinder are shown without a head piece attached. Referring to FIG. 12, a further alternative embodiment of the present invention is set forth.

The present invention has been described with reference to the enclosed figures. It is to be appreciated that the true nature and scope of the present invention is to be determined with reference to the claims attached herein.

I claim:

1. An attachment for a palm nailer comprising:
a cylindrical portion having a receiving end and a non-receiving end;
the receiving end being pneumatically operable with a palm nailer; and
a flat or curved head piece attached to the non-receiving end that is suitable for planishing metal.

2. The device of claim 1 wherein the non-receiving end is threaded.

3. The device of claim 2 wherein the head piece is attachable to the non-receiving end of the attachment through its threads, the head piece having a threaded recess for attaching to the non-receiving end of the device.

4. An attachment for a palm nailer comprising:
a cylindrical portion with a receiving end and a non-receiving end;
the receiving end having an aperture through which it is pneumatically powered by the palm nailer;
the non-receiving end being substantially threaded for receiving a head piece; and
a head piece having a threaded recess through which it is attachable to the non-receiving end.

5. The device of claim 4 wherein the head piece is circular and substantially flat on the side that engages the metal to be planished.

6. The device of claim 4 wherein the engaging portion of the head piece is spherical.

7. The device of claim 4 wherein the engaging portion of the head piece is ovoid.
